(19) United States
(12) Patent Application Publication
(10) Pub. No.: US 2024/0346913 A1
(43) Pub. Date: Oct. 17, 2024

(54) CREW SAFETY SYSTEM

(71) Applicant: Sealution BV, Volkegem (BE)

(72) Inventor: Sebastian HAMERS, Volkegem (BE)

(21) Appl. No.: 18/291,829

(22) PCT Filed: Nov. 9, 2022
(86) PCT No.: PCT/EP2022/081248

§ 371 Date: Jan. 24, 2024

(30) Foreign Application Priority Data
Nov. 9, 2021 (EP) 21207303.5

(51) Int. Cl. G08B 25/01; G08B 21/02; G08B 25/06; G08B 25/10; G08B 25/12; H04W 4/80; H04W 4/90

(52) U.S. Cl. CPC G08B 25/016; G08B 21/02; G08B 25/06; G08B 25/10; G08B 25/12; H04W 4/80; H04W 4/90

(57) ABSTRACT

The current invention relates to a crew safety system for monitoring persons on a ship. The system comprising a plurality of wearables in a two way connection with at least one room module, said room module being in a two way connection with a central module. Said two way connection between each room module and the central module being provided by cabling of a fire safety system. The invention permits the monitoring of the status of a number of crew members and the environment they work in while being advantageously easy and inexpensive to install, run and operate.

### FIELD OF THE INVENTION

The present invention relates to a safety system. In particular, the present invention relates to a crew safety system.

### BACKGROUND

There are several safety systems directed at crew safety disclosed in prior art.

KR20090019410A in the name of The Korea Institute of Ocean Science and Technology disclosed a location tracking system and method for crews and passengers in a cruise ship. A power line modem is installed in a small and low power active tag, a router installed in a wall, and a power line installed in the ship. However, the disclosed system a tracking function and offers no further safety monitoring capabilities.

WO2015019372A1 in the name of MARTEC S. P. A. discloses a system for tracking the position of persons or items in structures provided with rooms intended to receive persons or items, such as ships, buildings, or offshore platforms. The system disclosed in this document offers limited crew location detection possibilities.

U.S. Pat. No. 20,150,334530 in the name of John Christian Scott discloses a system of room modules, connected to a central module, wherein user devices can connect to the room modules, to provide position information. However, the system is ill-configured for maritime use, has connection issues and requires substantial adaptations to the vessel to be used.

The present invention aims to resolve at least some of the problems and disadvantages mentioned above. The aim of the invention is to provide a method which eliminates those disadvantages. The present invention targets at solving at least one of the aforementioned disadvantages.

The invention thereto aims to provide a crew safety system which permits locating and monitoring the status of each crew member. Furthermore, the system also permits the monitoring of the environment surrounding each crew member.

### SUMMARY OF THE INVENTION

The present invention and embodiments thereof serve to provide a solution to one or more of above-mentioned disadvantages. To this end, the present invention relates to a crew safety system for monitoring persons on a ship according to claim 1. The system comprising a plurality of wearables in a two-way connection with at least one room module, said room module being in a two-way connection with a central module. Said two-way connection between each room module and the central module being provided by cabling of a fire safety system.

Preferred embodiments of the device are shown in any of the claims 2 to 15.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows a schematic representation of the crew safety system and its elements in accordance with claim 1.

### DETAILED DESCRIPTION OF THE INVENTION

The present invention concerns crew safety system for monitoring persons on a ship.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or >7 etc. of said members, and up to all said members.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect the invention relates to a crew safety system for monitoring persons on a ship comprising:
a. at least one wearable device configured to monitor and collect input from the person, comprising a Bluetooth Low Energy component for transmitting information, wherein each wearable device is provided with a unique identifier;
b. a plurality of room modules, comprising a Bluetooth Low Energy component, and configured to communicate with the wearable device by means of Bluetooth Low Energy; and
c. a central module configured to communicate with each room module and by means of which receive, request and process information collected by each wearable device;

wherein each room module is connected to the central module by means of cabling of a fire safety system in said ship, allowing communication between the room modules and the central module. As is generally known, costs related to installation of emergency systems constitute a substantial cost, sometimes matching or even exceeding the cost of the elements of the whole emergency system. In particular, fire safety systems are ubiquitous and mandatory in all ships, these system are further configured to reliably convey sensor signals and information to a central control unit in a two way communication mode. By making use of the cabling of existing fire safety system as a means of communication between each room module and the central module, installation cost of the crew safety system is minimal. Furthermore, the crew safety system advantageously benefits from reduced maintenance costs as only one cable system must be checked and maintained for both the fire safety system and the crew safety system. One of the substantial issues with existing crew safety monitoring systems, is that it is very difficult to get accurate signals inside of ships via conventional means, such as RFID, Wi-Fi, etc., due to the structure of the ships, which makes the need of high proximity to achieve the required connectivity between the wearable component and the static component very difficult, and the ubiquitousness of metals that interfere with these signals over longer ranges. Furthermore, use of RFID typically reduces the extent to which information can be exchanged, and does not allow dynamic information exchanges (for instance, info from sensors of the wearable). The use of BLE in this aspect solves many of the aforementioned problems, allowing a higher range and thus improved connectivity, relatively low power consumption, dynamic exchange of information. The higher range can also be used to substantially overcome any undue interference from metal in the environment.

The room modules communicate with the central modules over a signal with a frequency of at least 25 kHz, preferably at least 50 kHz, even more preferably at least 100 KHz.

In order not to disturb the signals that the fire safety system itself uses and communicates with over said cabling, typically with lower frequencies around or of at most 5 kHz, the crew monitoring signals use higher frequencies, thereby avoiding (too much) interference with the fire safety system signals. Further advantages of using a higher frequency is that this has more bandwidth and allows faster/more voluminous data transfer. Given that the fire safety system signals are less data-intensive, it is advantageous that these use the lower frequencies, while the room modules, which can also send sensor data and thus have more data to send, use the higher frequencies.

Preferably, the BLE component is always operational. The components used for communication with the central module over the fire system cabling is only activated when there is data to send.

In a preferred embodiment, the room module is configured to be mounted onto pre-existing bases onto which fire alarm modules are fixed, and comprise a mounting means themselves onto which the fire alarm modules can be mounted, to save place.

The term “information” can refer to a number of features. In first instance, this comprises a way of identifying the wearable device and thus the crew member wearing it (preferably, the devices are coupled to a person in a central database, preferably available or in the central module). Identification can be via a number of means, such as a MAC address, an identification code or other means. Further information can then include environmental data (temperature, CO₂ level, oxygen level, etc.), biometrics of the wearer (heartrate, velocity, acceleration or absence thereof, etc.), and other information.

This information can then be appended by the room modules with further room information, for subsequent communication to the central module. This room information comprises a room or unit identification (again, a number of means is possible to achieve this), and optionally further data, such as environmental room data. Preferably, the room modules are provided with unit identifications, which are provided to the central module, along with the room to which said unit identification, and thus said room module, is associated to. This unit identification can be provided as a code in, wherein the identification can be changed via a physical feature on the room module itself, for instance via one or more rotary switches, an electronically settable identification means (preferably with a screen) and/or others. This allows qualified personnel to install/repair and set the identification for the room module, but also replace room modules without needing to register it centrally, as the identification code remains the same. The room module will then automatically include the correct unit identification in signals it sends to the central module. Preferably, the means with which the unit identification can be set and changed can be shielded and/or locked from outside interaction, to ensure only authorized personnel can interact.

According to a further or another embodiment, the wearable device includes a distress signaling function. Preferably, the distress signaling function is configured to be activated by the wearer. More preferably, the activation of the distress function causes a report to be compiled and sent to the central module. Said compiled information preferably includes a unit identification assigned to the specific wearable issuing the wearable signal, as well as, the identification of the room module receiving the distress signal. This allows monitoring personnel at the central module to easily discern the person requesting assistance, and if necessary adjust for their specific circumstances, possibly based on medical records, and the exact location.

In a further or another embodiment, the room modules are configured to draw power from the fire alarm system. In this way installation of the system is further simplified, avoiding the need to install new cabling of to acquire new power sources to power the system. Preferably, the room modules are provided with a universal interface which permits direct plugging of the module to the fire alarm system. More preferable still, the room modules can use a single connection element for power and data connectivity with the fire safety system.

Alternatively or additionally, an external power supply is used to provide power to the room modules. In some cases, depending on the fire alarm system and/or the room module itself, insufficient power can be drawn therefrom. This can be supplemented or replaced entirely by the external power supply, for instance via a wired connection to the electrical power net of the vessel.

In order to further reduce power consumption, some components of the room module are only activated periodically, while others remain operation at all times. For instance, the BLE component for communication with the wearables remains on at all times to detect any (new and old) wearable in its range. Other parts of the room module, such as the components for communicating with the central module can be activated only periodically, for instance every 1 minute, 2 minutes, 5 minutes, 10 minutes, 15 minutes, etc., to conserve power, or can be activated upon detection of an event, such as the detection of a new wearable or departure of a previously detected wearable, and then transmits the gathered data regarding the event (and optionally less urgent data that was gathered previously). The activation can be performed actively, or can be triggered passively, for instance by the central module sending a request.

Further considerations can be provided to the room modules to make them self-sufficient, such as an internal battery that is rechargeable. This way, it can be selfsustainable on the energy of the fire system with only the always operational components activated (“off-times) but may not be so when more components are active (“on-times). In such a case, the battery can recharge during the “off-times”, to use the recharged energy during the “on-times”. Alternatively or additionally, other charging solutions can be implemented such as energy harvesting means, which is especially useful in maritime travel due to the constant movement), etc.

In a preferred embodiment, the room modules are supplied with visual indicators, for instance (LED) lights, to indicate whether the room module is in communication with the central module. This allows easy and fast detection of defective room modules, and reparation/replacement thereof.

According to a further or another embodiment, the wearable device comprises an input means, preferably a button, and the central module is configured to periodically trigger each wearable device to request the user for input, preferably via a tactile and/or visual and/or auditive signal. This permits checking the status of each crew member, the correct functioning of the wearable device and provides a timely warning to the central module, and those monitoring it, in case of non-respondence by the crew member. Furthermore, audio and/or visual signals provide for the additional effect of assisting in finding the exact location of the crew member (for instance, when in a large room with a lot of objects, such as a cargo hold).

There may be instances where communication between a wearable device and a room module may be broken due to poor reception. For example, a crew member must operate in a confined space where placing a room module is not feasible, such as inside a boiler shell. In a further or another embodiment, the wearable device comprises an input means, preferably a button, and the wearable device is configured to periodically request the user for input, preferably via a tactile and/or visual and/or auditive signal. By preference, the room module sends a signal back to the wearable device in order to confirm the reception of the signal first issued by said wearable. More preferably, upon receiving a confirmation from the room module, the wearable device provides feedback to the user by means of a tactile and/or visual and/or auditive signal, which signal is distinct form the first signal requesting the user for input. In this way the user is made aware if there is poor communication between the wearable device and the room module.

In a preferred embodiment, the room modules are configured to communicate to the central module with a minimal waiting time between each communication, said waiting time being at least 50 msec, preferably at least 100 msec, even more preferably at least 150 msec, even more preferably at least 250 msec, or even 500 msec. Since a plurality of room modules share the same cabling (of the fire safety system), sufficient time must be left between sending separate data packets, to allow each module to send their data. The minimal waiting time is increased as more room modules share a single cabling, and can be increased accordingly, and preferably automatically. In a preferred embodiment, the room modules comprise a communication component, for instance a PLC module, equipped for Power Line Communication with the central module, over the fire system cabling. The central module is also provided with a communication component, typically also a PLC module similar or equal to that of the room modules, and capable of Power Line Communication. This communication can be according to a predetermined protocol such as G3-PLC.

In a preferred embodiment, the central module comprises USB and ethernet capabilities, allowing it to be connected to other devices for information exchange.

In a preferred embodiment, the central modules comprises one or more removable memory means, for instance an SD or SSD card, eMMC (embedded MultiMediaCard), or others.

Preferably the room modules are provided with a shell protecting the internal components, and preferably having openings for connecting the room modules to external devices. Preferably, the same is true for the central module.

In a preferred embodiment, the system comprises one, but preferably at least two, server, which receives and stores the gathered data from the central module, and allows further processing on other devices (for instance, personal computer, etc.). The presence of a second or even third server, provides for a failover mechanism in case of damage.

In a first or another embodiment, the wearable device is configured to communicate a distress signal to the room module upon failure to respond to the request for input within a predetermined time period, preferably between 5 minutes and 1 hour, more preferably between 10 minutes and 30 minutes, for instance 15 minutes. By preference, these periods are adjustable according to the work allocated to a crew member and/or to the room(s) where said crew member passes/is in. More preferably, the periods are adjustable also according to rate of change of concentrations of hazardous substances or accident incidence per room. This advantageously permits adjusting the periods to the risk and hazards associated to a particular are or room of the vessel.

In some embodiments, the wearable device can be configured to allow the user to reset the predetermined period, thereby restarting the period after which the request for input will be issued. This reset can be performed via a separate button or input means, or the same as the original one used to provide input. This way, the user can make sure not to be bothered for a certain amount of time, which is convenient when having to deal with an activity that requires focus.

In a preferred embodiment, the wearable comprises a rechargeable power supply, wherein the power supply is suitable for at least powering the device for 24 hours, but preferably substantially more.

In a preferred embodiment, the wearable can be provided uniformly, as a single type of item, such as a pendant, ring, bracelet or armband, necklace, pin (lapel, collar, etc.) or button, watch, etc., or can be a homogenous mix of two or more types, allowing crew members to choose according to preference and/or specific regulations (for instance, engine crew may have regulations against wristwear). The wearable can also be provided as a device that can be integrated into clothing.

In a further or another embodiment, each room module has a unit identification, and wherein the central module is provided with a database of the unit identifications and the locations of the associated room modules. More preferably, the exact location of each room module within a room is provided to the central module. In this way, the location of crew members can be tracked more accurately. In particular in situations where the same wearable is detected by multiple units, strength of the signal captured by each room module and precise room module location can be used for a more precise location of a crew member. Again, this is an advantage of use of RFID and BLE. In particular, BLE as a preferred option would allow more precise localization by using the RSSI (Received Signal Strength Indicator) of the wearable. This allows the system to pinpoint the exact position of the crewmember in distress via triangulation.

In a preferred embodiment, a room module can be provided at a doorway of a room, preferably at each doorway of said room. This ensures that the wearable is detected upon entry, even if the device then proceeds to go out of range in the room. Based on previous detections, the exact position of the crew member (which way did he go through the doorway) can be ascertained, or this can be achieved via positioning the room module inside of the room and monitoring RSSI of the received signal during the connection (whether there's a strong decline at the end or a rapid increase at first in strength of the signal can be evidence of respectively leaving a room or entering a room). Alternatively, the room module is provided centrally in the room, or even at a number of locations throughout the room. These room modules can be coupled to correspond to a single ‘master module’ for said room, which performs the communication with the central module, or alternatively each of said room modules can perform the communication themselves.

In a further or another embodiment, the central module is configured to pass information for visual representation. By preference, said information includes identification of all wearables, identification and location of the room modules associated to each wearable, conditions surrounding each wearable and each room module and biological signals captured by each wearable. More preferably, history of verification signals of each room module and each wearable are also passed for visual representation.

In a further or another embodiment, the wearable device comprises a wear sensor configured to detect if a person is wearing the wearable device, preferably an accelerometer and/or a heart rate monitor. This advantageously permits assessing the condition of the user even within environments where sound or vibration prevent the user of a wearable from noticing a verification signal coming from the wearable device. More advantageously still, the wear sensor permits detecting when the wearer is in distress.

In a further or another embodiment, the room modules are configured to automatically register the unique identifier of the wearable device when communicating with said wearable device. By preference, the unique identifier is registered with a timestamp. More preferably, said registered unique identifier is communicated to the central module, preferably either upon registration or periodically, along with a unit identification of said room module. In this way, each wearable can be tracked not only in space but also in time.

The unique identifier can provided in a number of fashions, such as a code assigned to the wearable, that is automatically appended to communications, but can also simply be the MAC address of the BLE component or from another communication component.

In a preferred embodiment, the system is further provided with a plurality of sensor components, which can be positioned in the rooms via a myriad of ways directly attached or integrated to the room modules or separate therefrom (fastening techniques, loose sensor, etc.), but preferably separate as this allows a freer and more efficient positioning (for instance, smoke detector closer to ceiling), which is often relevant for the measured parameter, as well as allowing easy and fast reconfiguration. The sensor components are preferably provided with a BLE communication module, allowing communication to (and preferably also from) the room modules of which it is in proximity of. The sensors can be aimed at a number of functions, but mainly focus on environmental safety conditions, such as presence of certain undesirable gases (CO₂, CO), but can also comprise smoke detectors, (ambient) temperature sensors, air humidity sensors, etc. The sensor components can be provided separately, or combined into a single sensor unit, which comprises several sensor components, and may share a BLE communication module.

The sensor components communicate wirelessly with the room modules via BLE, and via the room modules, provide their data to the central module. This way, there is no need for a cabled installation of the sensors, and they can simply piggy-back via the room modules, who are in turn piggy-backing over the fire safety system cables.

According to a further or another embodiment each room module is configured to monitor and transmit information related to its surroundings. This is particularly advantageous as hazardous substances which are not easily detectable by human senses alone are very likely occur in ships. By preference, each room module is configured detect and monitor concentrations of CO and CO₂ in its surrounding atmosphere which substances are hazardous, scentless and colorless. Said substances are of common occurrence in ships, in particular in spaces under the deck, more in particular, engine rooms, kitchens and cargo holds. Still more preferably, each room module is configured to detect and monitor concentration of hydrocarbons in its surrounding atmosphere. This is particularly advantageous in, but not limited to, tankers and cereal transportation ships. Still more preferably, each room module is configured to detect and monitor the presence and concentration of inert gases in its surrounding atmosphere. The detection of any of the aforementioned is highly advantageous as the room module can trigger wearables to warn crew members of the presence of hazardous atmospheres, allowing them to take action and avoid/remedy the hazard. Should such atmospheres otherwise remain undetected, these would likely to result in the death of the crew members within them. Yet more preferable, the wearable devices have the same detection capabilities as the room modules. This is particularly advantageous as some hazardous substances tend to accumulate at different heights. By having the same detection capabilities of the room module incorporated also in the wearable device, the detection capacity of the system in greatly amplified. Furthermore, by extending the detection capabilities of the wearable device, a shorter detection time is attained, thereby, reducing exposure of the crew members to the aforementioned hazardous substances.

In a further or another embodiment, the room modules and the wearable devices are configured to automatically connect when in each other's range, and wherein the room modules are configured to automatically register the unique identifier of the wearable device when communicating with said wearable device upon connection, preferably with a timestamp of the registration and/or connection. By preference, the wearable device will search for new room modules if a sharp decrease in signal strength is detected. In this way, the chances of a wearable device not being connected to a room module are greatly diminished, therefore, advantageously improving the safety of the crew member wearing the wearable device is also improved.

The invention is further described by the following non-limiting examples which further illustrate the invention, and are not intended to, nor should they be interpreted to, limit the scope of the invention.

### Description of Figures

With as a goal illustrating better the properties of the invention the following presents, as an example and limiting in no way other potential applications, a description of the crew safety system, wherein:

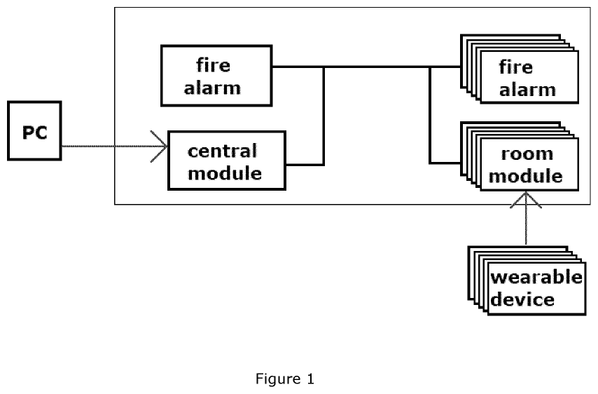

FIG. 1 shows a schematic representation of the crew safety system and its elements in accordance with claim 1. This figure shows a schematic representation of a system wherein the wearables are bracelets assigned and worn by crew members. Said bracelets are in communication with at least one of a number (for instance 150) of room modules. Said room modules are installed on the cabling of an existing fire alarm system, which cabling permits the communication of each room module with the central module. A PC external to the system is shown connected to the central module.

The present invention is in no way limited to the embodiments described in the figure. On the contrary, systems according to the present invention may be realized in many different ways without departing from the scope of the invention. Other embodiments of the crew safety system are possible and, in which embodiments, the wearables worn by crew members are pendants.

1. Crew safety system for monitoring persons on a ship comprising:
a. at least one wearable device configured to monitor and collect input from a person, wherein each wearable device is provided with a unique identifier;
b. a plurality of room modules, wherein each room module has a unit identification, and wherein the central module is provided with a database of the unit identifications and the locations of the associated room modules; and
c. a central module configured to communicate with each room module and receive, request and process information collected by each wearable device from the room modules;
wherein the at least one wearable device comprises a Bluetooth Low Energy component for transmitting information;
in that the room modules comprise a Bluetooth Low Energy component and are configured to communicate with the at least one wearable device by means of Bluetooth Low Energy;
and in that each room module is connected to the central module by means of cabling of a fire safety system in said ship, allowing communication between the room modules and the central module, and wherein the room modules communicate with the central module at a signal frequency of at least 25 kHz.

2. A crew safety system for monitoring persons on a ship according to claim 1, wherein the wearable device includes a distress signaling function.

3. A crew safety system for monitoring persons on a ship according to claim 2, wherein the distress signaling function is configured to be activated by the wearer.

4. A crew safety system for monitoring persons on a ship according to claim 1, wherein the room modules are configured to draw power from the fire alarm system.

5. Crew safety system for monitoring persons on a ship according to claim 1, wherein the wearable device comprises an input means, preferably a button, and the central module is configured to periodically trigger each wearable device to request the user for input, preferably via a tactile and/or visual and/or auditive signal.

6. Crew safety system for monitoring persons on a ship according to claim 1, wherein the wearable device comprises an input means, and the wearable device is configured to periodically request the user for input.

7. A crew safety system for monitoring persons on a ship according to claim 5, wherein the wearable device is configured to communicate a distress signal to the room module upon failure to respond to the request for input within a predetermined time period.

8. A crew safety system for monitoring persons on a ship according to claim 1, wherein the room modules communicate with the central module at a signal frequency of at least 50 kHz.

9. A crew safety system for monitoring persons on a ship according to claim 1, wherein the central module is configured to pass information for visual representation.

10. A crew safety system for monitoring persons on a ship according to claim 1, wherein the wearable device comprises a wear sensor configured to detect if a person is wearing the wearable device.

11. A crew safety system for monitoring persons on a ship according to claim 1, wherein the room modules are configured to automatically register the unique identifier of the wearable device when communicating with said wearable device.

12. A crew safety system for monitoring persons on a ship according to claim 11, wherein the unique identifier is registered with a timestamp.

13. A crew safety system for monitoring persons on a ship according to claim 11, wherein said registered unique identifier is communicated to the central module along with a unit identification of said room module.

14. A crew safety system for monitoring persons on a ship according to claim 1, wherein each wearable device is configured to monitor and transmit information related to its surroundings.

15. A crew safety system for monitoring persons on a ship according to claim 1, wherein the system is further provided with a plurality of sensor components separate from the room modules, wherein said sensor components are configured to communicate wirelessly with the room modules, said communication comprising transmission of sensor data to the room modules.

16. A crew safety system for monitoring persons on a ship according to claim 1, wherein the room modules and the wearable devices are configured to automatically connect when in each other's range, and wherein the room modules are configured to automatically register the unique identifier of the wearable device when communicating with said wearable device upon connection.

17. A crew safety system for monitoring persons on a ship according to claim 1, wherein the unit identification is settable on the room module, and wherein information sent from the room module to the central module comprises the unit identification of the room module.

18. A crew safety system for monitoring persons on a ship according to claim 1, wherein the room modules are configured to communicate to the central module with a minimal waiting time between each communication, said waiting time being at least 50 msec.
